(19) United States
(12) Patent Application Publication
(10) Pub. No.: US 2013/0216709 A1
(43) Pub. Date: Aug. 22, 2013

(54) Film Formation Apparatus, Method for Forming Film and Method for Cleaning Shadow Mask

(71) Applicant: Semiconductor Energy Laboratory Co., Ltd., (US)

(72) Inventors: Shunpei Yamazaki, Tokyo (JP); Shingo Eguchi, Atsugi (JP)

(73) Assignee: Semiconductor Energy Laboratory Co., Ltd., Kanagawa-ken (JP)

(21) Appl. No.: 13/768,150

(22) Filed: Feb. 15, 2013

(30) Foreign Application Priority Data
Feb. 17, 2012 (JP) JP 2012-032933

(51) Int. Cl. B05C 21/00

(52) U.S. Cl. CPC B05C 21/00
USPC 427/248.1; 118/720

(57) ABSTRACT

A film formation apparatus that can remove a film formation material attached to a shadow mask is provided. Alternatively, a method for forming a film and a method for cleaning a shadow mask are provided. The film formation apparatus includes a film formation chamber including an evaporation source; a shadow mask transfer mechanism; and a plasma source. The shadow mask transfer mechanism includes a first mode in which a film is formed on an object to be film-formed with a film formation material ejected by the evaporation source while the object to be film-formed and a shadow mask are transferred, and a second mode in which plasma irradiation is performed by the plasma source to remove the film formation material attached to the shadow mask while the evaporation source is parted from the plasma source by a sluice valve and the shadow mask is transferred.

### BACKGROUND OF THE INVENTION

1. Field of the Invention

The present invention relates to a film formation apparatus, a method for forming a film using the film formation apparatus, and a method for cleaning a shadow mask used in the film formation apparatus.

2. Description of the Related Art

An apparatus which ejects a film formation material towards a surface of an object to be film-formed to form a film with the film formation material has been known. For example, a film formation apparatus (also referred to as an evaporation apparatus) which includes a film formation chamber provided with an evaporation source filled with a film formation material and which ejects the film formation material vaporized in the film formation chamber from the evaporation source to form a film on a surface of an object to be film-formed has been known.

A film formation apparatus which can efficiently utilize a film formation material is preferred. For example, a method in which an evaporation source having directivity in a direction in which a film formation material is ejected is kept close to an object to be film-formed and in which a film is formed while the object to be film-formed is scanned with the evaporation source has been known.

However, in some cases, part of the film formation material is unintentionally attached to a place other than the surface of the object to be film-formed (e.g., an inner wall of the film formation chamber, a partition plate provided near the evaporation source, or a shadow mask) and is wasted.

Moreover, part of a film which is deposited on a place other than the surface of the object to be film-formed every time film formation is repeated might be separated for some reason (e.g., stress generated in the film) and be diffused in the film formation chamber as a membranous or powdery substance (also referred to as a dust). Such a membranous or powdery substance is attached to the object to be film-formed and degrades the quality of a film formed on the object to be film-formed and causes generation of a defect.

Further, as a method for forming an island-like film on a surface of an object to be film-formed, a shadow mask method has been known. The shadow mask method is a method for forming a film by using a shadow mask having openings placed near a surface of an object to be film-formed on the evaporation source side, which enables an island-like film corresponding to the shapes of the openings of the shadow mask to be formed on the surface of the object to be film-formed.

In the shadow mask method, a film formation material which does not reach the object to be film-formed to form a film is attached to and deposited on a surface of the shadow mask on the evaporation source side, and this causes a membranous or powdery substance to be generated. Further, when the shadow mask to which a membranous or powdery substance is attached is placed near the object to be film-formed and is used, in some cases, the membranous or powdery substance might be transferred to the object to be film-formed from the shadow mask. Therefore, it is necessary to change or clean a shadow mask regularly to control the amount of the film formation material which is deposited on the shadow mask.

In order to suppress generation of such a membranous or powdery substance, Patent Document 1 discloses an invention related to an attachment prevention means which removes a film formation material attached to an inner wall by generating plasma in a film formation chamber or to a cleaning method of a mask.

In order to clean the film formation material attached to the mask, Patent Document 2 discloses an invention related to a method in which plasma is generated in a film formation chamber with a plasma generator and thus a film formation material attached to a mask is vaporized and exhausted to the outside of the film formation chamber.

### REFERENCE

[Patent Document 1] Japanese Published Patent Application No. 2003-313654
[Patent Document 2] Japanese Published Patent Application No. 2004-047452

### SUMMARY OF THE INVENTION

When a film formation material attached to a shadow mask is exposed to plasma, the film formation material can be vaporized by a reaction or a sputtering phenomenon. Then, the vaporized substance is exhausted and removed from a film formation chamber by an exhaust unit, whereby a shadow mask can be cleaned.

A material without an impurity which is contained unintentionally is preferred as the film formation material; however, when the film formation material attached to the shadow mask is removed by plasma in the film formation chamber provided with an evaporation source, the film formation material in the evaporation source might be contaminated with the vaporized substance.

One embodiment of the present invention is made in view of the foregoing technical background. Accordingly, one object is to provide a film formation apparatus that can remove a film formation material attached to a shadow mask. Another object is to provide a method for forming a film and a method for cleaning a shadow mask.

In order to achieve at least one of the above-described objects, one embodiment of the present invention is made with a focus on a vaporized substance which is generated by exposure of a film formation material attached to a shadow mask to plasma. Consequently, the inventors have devised a film formation apparatus having a structure exemplified in this specification, and a method for forming a film and a method for cleaning a shadow mask which use the film formation apparatus.

A film formation apparatus of one embodiment of the present invention includes a film formation chamber including an evaporation source; a shadow mask transfer mechanism; and a plasma source. The shadow mask transfer mechanism further includes a first mode and a second mode. In the first mode, a film is formed on an object to be film-formed with a film formation material ejected by the evaporation source while the object to be film-formed and a shadow mask are transferred in a state of being overlapped with each other by the shadow mask transfer mechanism. In the second mode, plasma irradiation is performed by the plasma source to remove the film formation material attached to the shadow mask while the evaporation source is parted from the plasma source by a sluice valve and the shadow mask is transferred in a state where the shadow mask is held by the shadow mask transfer mechanism.

In other words, according to one embodiment of the present invention, the film formation apparatus includes the film formation chamber that includes a film formation start position, a film formation end position, the evaporation source, a first sluice valve, and the plasma source; and the shadow mask transfer mechanism which transfers a shadow mask between the film formation start position and the film formation end position. The shadow mask transfer mechanism is provided to perform a first transfer operation and a second transfer operation. In the first transfer operation, a shadow mask whose one surface side faces an object to be film-formed (e.g., a substrate) is transferred from the film formation start position to the film formation end position in the film formation chamber. In the second transfer operation, the shadow mask is transferred from the film formation end position to the film formation start position. The evaporation source is provided so as to eject a film on the object to be film-formed from the other surface side of the shadow mask with the film formation material during the first transfer operation. The plasma source is provided so as to remove the film formation material attached to the shadow mask by irradiating the other surface side of the shadow mask with plasma during the second transfer operation. While plasma irradiation is performed by the plasma source, the first sluice valve is provided so as to part the evaporation source from the plasma source.

In the above film formation apparatus of one embodiment of the present invention, during the second transfer operation in which the shadow mask is transferred from the film formation end position to the film formation start position, the evaporation source is parted from the plasma source by the first sluice valve and the shadow mask is irradiated with plasma by the plasma source, whereby the film formation material attached to the shadow mask is removed. Accordingly, the film formation material attached to the shadow mask can be removed without contaminating the film formation material in the evaporation source. Consequently, a film formation apparatus that can remove a film formation material attached to a shadow mask can be provided. Moreover, with the use of the film formation apparatus, it is possible to prevent entry of an impurity into the film formation material in the evaporation source and reduce the frequency of occurrence of defects in a film to be formed, which is caused by the film formation material attached to the shadow mask.

According to another embodiment of the present invention, a film formation apparatus includes a film formation chamber that includes a film formation start position, a film formation end position, and an evaporation source; a removal chamber that includes a removal start position, a removal end position, and a plasma source; a first sluice valve between the film formation end position and the removal start position; a second sluice valve between the removal end position and the film formation start position; and a shadow mask transfer mechanism which transfers a shadow mask between the film formation start position and the film formation end position. The shadow mask transfer mechanism is provided to perform a first transfer operation and a second transfer operation. In the first transfer operation, a shadow mask whose one surface side faces an object to be film-formed (e.g., a substrate) is transferred from the film formation start position to the film formation end position in the film formation chamber. In the second transfer operation, the shadow mask is transferred from the film formation end position to the film formation start position via the removal start position and the removal end position in order. The evaporation source is provided so as to eject a film on the object to be film-formed from the other surface side of the shadow mask with a film formation material during the first transfer operation. The plasma source is provided so as to remove the film formation material attached to the shadow mask by irradiating the other surface side of the shadow mask with plasma during the second transfer operation. While plasma irradiation is performed by the plasma source, the first sluice valve and the second sluice valve are provided so as to part the evaporation source from the plasma source.

In the above film formation apparatus of another embodiment of the present invention, during the second transfer operation in which the shadow mask is transferred from the film formation end position to the film formation start position, the evaporation source is parted from the plasma source by the first sluice valve and the second sluice valve and the shadow mask is irradiated with plasma by the plasma source, whereby the film formation material attached to the shadow mask is removed. Accordingly, the film formation material attached to the shadow mask can be removed without contaminating the film formation material in the evaporation source. Consequently, a film formation apparatus that can remove a film formation material attached to a shadow mask can be provided. Moreover, with the use of the film formation apparatus, the film formation material attached to the shadow mask can be removed in the removal chamber which is different from the film formation chamber; therefore, it is possible to prevent entry of an impurity into the evaporation source and reduce the frequency of occurrence of defects in a film to be formed, which is caused by the film formation material attached to the shadow mask.

According to another embodiment of the present invention, the above film formation apparatus further includes a first pressure adjustment chamber between the first sluice valve and the removal chamber, which is partitioned from the removal chamber with a third sluice valve; and a second pressure adjustment chamber between the second sluice valve and the removal chamber, which is partitioned from the removal chamber with a fourth sluice valve. Instead of the above second transfer operation, the shadow mask transfer mechanism is provided to perform a second transfer operation in which the shadow mask is transferred from the film formation end position to the film formation start position via the first pressure adjustment chamber, the removal start position, the removal end position, and the second pressure adjustment chamber in order.

In the above film formation apparatus of another embodiment of the present invention, during the second transfer operation in which the shadow mask is transferred from the film formation end position to the film formation start position, the evaporation source is parted from the plasma source by the first pressure adjustment chamber and the second pressure adjustment chamber and the shadow mask is irradiated with plasma by the plasma source, whereby the film formation material attached to the shadow mask is removed. Accordingly, the pressure of the removal chamber can be kept at a pressure appropriate for removal of the film formation material and the pressure of the film formation chamber can be kept at a pressure appropriate for film formation, and further the film formation material attached to the shadow mask can be removed without contaminating the film formation material in the evaporation source. Consequently, a film formation apparatus that can remove a film formation material attached to a shadow mask can be provided. Moreover, with the use of the film formation apparatus, it is possible to prevent entry of an impurity into the evaporation source and reduce the frequency of occurrence of defects in a film to be formed, which is caused by the film formation material attached to the shadow mask.

According to another embodiment of the present invention, the above film formation apparatus further includes a power source electrically connected to the shadow mask. During the second transfer operation, the power source controls a potential of the shadow mask so that part of plasma generated by the plasma source is drawn to the shadow mask.

The above film formation apparatus of another embodiment of the present invention can selectively clean the shadow mask by drawing part of plasma to the shadow mask. Accordingly, the film formation material attached to a complicated portion of the shadow mask can be removed. Further, the shadow mask can be selectively irradiated with plasma having high capability of removing the film formation material attached to the shadow mask. Consequently, a film formation apparatus that can remove a film formation material attached to a shadow mask can be provided. Moreover, with the use of the film formation apparatus, it is possible to reduce the frequency of occurrence of defects in a film to be formed, which is caused by the film formation material attached to the shadow mask. Further, the film formation material attached to the shadow mask can be removed efficiently.

According to another embodiment of the present invention, the above film formation apparatus further includes an evaporation source group and a storage chamber connected to the film formation chamber through the sluice valve. Evaporation sources of the evaporation source group are provided so as to be able to move between the film formation chamber and the storage chamber and to move parallel to one another in a direction in which the evaporation source group intersect with the direction of the first transfer operation. Further, the evaporation sources of the evaporation source group during the first transfer operation are arranged in the film formation chamber so as not to be aligned with one another. The evaporation source group is stored in the storage chamber during the second transfer operation.

In the above film formation apparatus of another embodiment of the present invention, the evaporation source group is provided so as to be able to move in a direction intersecting with the direction of the first transfer operation, and the evaporation sources of the evaporation source group during the first transfer operation are arranged in the film formation chamber so as not to be aligned with one another. Accordingly, a film with a large width can be formed in a direction intersecting with the direction of the first transfer operation without using a large-sized evaporation source. Note that a large-sized evaporation source is difficult to move; thus, film formation can be achieved by using a plurality of small-sized evaporation sources which can be moved easily.

During the second transfer operation, the evaporation source group is stored in the storage chamber to be parted from the plasma source, and the shadow mask is irradiated with plasma by the plasma source, whereby the film formation material attached to the shadow mask is removed.

Accordingly, the film formation material attached to the shadow mask can be removed. Consequently, a film formation apparatus that can remove a film formation material attached to a shadow mask can be provided. Moreover, with the use of the film formation apparatus, it is possible to prevent entry of an impurity into the evaporation source and reduce the frequency of occurrence of defects in a film to be formed, which is caused by the film formation material attached to the shadow mask.

The evaporation source group is provided so as to be able to move between the film formation chamber and the storage chamber and to move in a direction intersecting with the direction of the first transfer operation.

Accordingly, the evaporation source group that can form a film with a large width in a direction intersecting with the direction of the first transfer operation can be stored in the storage chamber. By particularly using a plurality of small evaporation sources, the length of the storage chamber which is projected from the side surface of the film formation chamber can be made short, and an occupation area or a footprint of the film formation apparatus can be made small. Further, by using the first sluice valve, the evaporation source group can be parted from the plasma source.

According to another embodiment of the present invention, a method for forming a film and a method for cleaning a shadow mask use a film formation apparatus including the following: a film formation chamber that includes a film formation start position, a film formation end position, an evaporation source, a first sluice valve, and a plasma source; and a shadow mask transfer mechanism which transfers a shadow mask between the film formation start position and the film formation end position. The shadow mask transfer mechanism is provided to perform a first transfer operation and a second transfer operation. In the first transfer operation, a shadow mask whose one surface side faces an object to be film-formed (e.g., a substrate) is transferred from the film formation start position to the film formation end position in the film formation chamber. In the second transfer operation, the shadow mask is transferred from the film formation end position to the film formation start position. The evaporation source is provided to eject a film on the object to be film-formed from the other surface side of the shadow mask with a film formation material during the first transfer operation. The plasma source is provided so as to remove the film formation material attached to the shadow mask by irradiating the other surface side of the shadow mask with plasma during the second transfer operation. While plasma irradiation is performed by the plasma source, the first sluice valve is provided so as to part the evaporation source from the plasma source. The above method for forming a film and method for cleaning a shadow mask include the following steps: a first step of, during the first transfer operation, ejecting a film formation material with the evaporation source from the other surface side of the shadow mask to form a film on an object to be film-formed; a second step of parting the evaporation source from the plasma source with the first sluice valve; a third step of irradiating the other surface side of the shadow mask with plasma by the plasma source to remove the film formation material attached to the shadow mask after the pressure of the film formation chamber is adjusted; and a fourth step of opening the first sluice valve to make the evaporation source capable of forming a film after the pressure of the film formation chamber is set equal to the pressure in the first step.

The above method for forming a film and method for cleaning a shadow mask of another embodiment of the present invention include the following step: during the second transfer operation in which the shadow mask is transferred from the film formation end position to the film formation start position of the film formation chamber, the shadow mask is irradiated with plasma by the plasma source with the evaporation source parted from the plasma source to remove the film formation material attached to the shadow mask. Accordingly, the film formation material attached to the shadow mask can be removed. Further, it is possible to suppress occurrence of a phenomenon in which a vaporized substance of the film formation material attached to the shadow mask is attached to the film formation material. Consequently, a method for forming a film and a method for cleaning a shadow mask can be provided. Moreover, with the use of the method for forming a film and the method for cleaning a shadow mask, it is possible to prevent entry of an impurity into the evaporation source and reduce the frequency of occurrence of defects in a film to be formed, which is caused by the film formation material attached to the shadow mask.

According to another embodiment of the present invention, a method for forming a film and a method for cleaning a shadow mask uses a film formation apparatus including the following: a film formation chamber that includes a film formation start position, a film formation end position, and an evaporation source; a removal chamber that includes a removal start position, a removal end position, and a plasma source; a first sluice valve between the film formation end position and the removal start position; a second sluice valve between the removal end position and the film formation start position; and a shadow mask transfer mechanism which transfers a shadow mask between the film formation start position and the film formation end position. The shadow mask transfer mechanism is provided to perform a first transfer operation and a second transfer operation. In the first transfer operation, a shadow mask whose one surface side faces an object to be film-formed (e.g., a substrate) is transferred from the film formation start position to the film formation end position in the film formation chamber. In the second transfer operation, the shadow mask is transferred from the film formation end position to the film formation start position in the removal start position, the removal chamber, and the removal end position in order. The evaporation source is provided so as to eject a film on the object to be film-formed from the other surface side of the shadow mask with a film formation material during the first transfer operation. The plasma source is provided so as to remove a film formation material attached to the shadow mask by irradiating the other surface side of the shadow mask with plasma during the second transfer operation. While plasma irradiation is performed by the plasma source, the first sluice valve and the second sluice valve are provided so as to part the evaporation source from the plasma source. The above method for forming a film and method for cleaning a shadow mask include the following steps: a first step of, during the first transfer operation, ejecting a film formation material with the evaporation source from the other surface side of the shadow mask to form a film on an object to be film-formed; a second step of opening the first sluice valve to carry in the shadow mask from the film formation end position of the film formation chamber to the removal start position of the removal chamber and closing the first sluice valve and the second sluice valve to part the evaporation source from the plasma source; a third step of irradiating the other surface side of the shadow mask with plasma by the plasma source to remove the film formation material attached to the shadow mask after the pressure of the removal chamber is adjusted; and a fourth step of opening the second sluice valve to carry in the shadow mask from the removal end position of the removal chamber to the film formation start position of the film formation chamber after the pressure of the removal chamber is set equal to the pressure of the film formation chamber.

The above method for forming a film and method for cleaning a shadow mask of another embodiment of the present invention include the following step: during the second transfer operation in which the shadow mask is transferred from the film formation end position to the film formation start position of the film formation chamber, the shadow mask is irradiated with plasma by the plasma source in the removal chamber whose pressure is different from that of the film formation chamber with the evaporation source parted from the plasma source, whereby the film formation material attached to the shadow mask is removed. Accordingly, the film formation material attached to the shadow mask can be removed. Further, it is possible to suppress occurrence of a phenomenon in which a vaporized substance of the film formation material attached to the shadow mask is attached to the film formation material in the evaporation source. Furthermore, the pressure of the film formation chamber can be kept at a pressure appropriate for film formation. Consequently, a method for forming a film and a method for cleaning a shadow mask can be provided. Moreover, with the use of the method for forming a film and the method for cleaning a shadow mask, it is possible to prevent entry of an impurity into the evaporation source and reduce the frequency of occurrence of defects in a film to be formed, which is caused by the film formation material attached to the shadow mask. Further, the film formation material in the evaporation source is unlikely to be contaminated with the vaporized substance. Furthermore, while the film formation material attached to the shadow mask used for film formation on one object to be film-formed is removed in the removal chamber through the third step, a film can also be formed on another object to be film-formed using another shadow mask in the film formation chamber through the first step; therefore, the efficiency of the film formation and cleaning can be improved.

According to another embodiment of the present invention, in the above method for forming a film and method for cleaning a shadow mask, a potential of the shadow mask is controlled so that part of plasma generated by the plasma source is drawn to the shadow mask in the third step.

The above method for forming a film and method for cleaning a shadow mask of another embodiment of the present invention include the following step: during the second transfer operation in which the shadow mask is transferred from the film formation end position to the film formation start position of the film formation chamber, the shadow mask is irradiated with plasma by the plasma source with the evaporation source parted from the plasma source to remove the film formation material attached to the shadow mask. Accordingly, the film formation material attached to the shadow mask can be removed. Further, it is possible to suppress occurrence of a phenomenon in which a vaporized substance of the film formation material attached to the shadow mask is attached to the film formation material. Further, part of plasma can be drawn to the shadow mask. Consequently, a method for forming a film and a method for cleaning a shadow mask can be provided. Further, with the method for forming a film and the method for cleaning a shadow mask, the film formation material in the evaporation source is unlikely to be contaminated with the vaporized substance. Furthermore, since part of plasma is drawn to the shadow mask, the time needed to remove the film formation material attached to the shadow mask can be reduced.

Note that in this specification, an “EL layer” refers to a layer provided between a pair of electrodes in a light-emitting element. Thus, a light-emitting layer containing an organic compound that is a light-emitting substance which is provided between electrodes is one mode of the EL layer.

In this specification, in the case where a substance A is dispersed in a matrix formed using a substance B, the substance B forming the matrix is referred to as a host material, and the substance A dispersed in the matrix is referred to as a guest material. Note that the substance A and the substance B may each be a single substance or a mixture of two or more kinds of substances.

Note that a light-emitting device in this specification means an image display device, a light-emitting device, or a light source (including a lighting device). In addition, the light-emitting device includes any of the following modules in its category: a module in which a connector such as a flexible printed circuit (FPC) or a tape carrier package (TCP) is attached to a light-emitting device; a module having a TCP provided with a printed wiring board at the end thereof; and a module having an integrated circuit (IC) directly mounted on a substrate over which a light-emitting element is foimed by a chip on glass (COG) method.

According to one embodiment of the present invention, a film formation apparatus that can remove a film formation material attached to a shadow mask used in a film formation chamber can be provided. Further, a method for forming a film and a method for cleaning a shadow mask used in a film formation chamber can be provided.

### BRIEF DESCRIPTION OF THE DRAWINGS

FIGS. 1A to 1C illustrate a structure of a film formation apparatus of one embodiment.

FIGS. 2A and 2B illustrate a structure of a film formation apparatus of one embodiment.

FIG. 3 illustrates a structure of a film formation apparatus of one embodiment.

FIGS. 4A to 4C illustrate a structure of a film formation apparatus of one embodiment.

FIGS. 5A to 5E each illustrate a structure of a light-emitting element of one embodiment.

FIGS. 6A to 6F illustrate structures of electronic devices of one embodiment.

### DETAILED DESCRIPTION OF THE INVENTION

Embodiments will be described in detail with reference to the drawings. Note that the present invention is not limited to the description below, and it will be easily understood by those skilled in the art that various changes and modifications can be made without departing from the spirit and scope of the present invention. Therefore, the present invention should not be construed as being limited to the description in the following embodiments. Note that in the structures of the invention described below, the same portions or portions having similar functions are denoted by the same reference numerals in different drawings, and description of such portions is not repeated.

### Embodiment 1

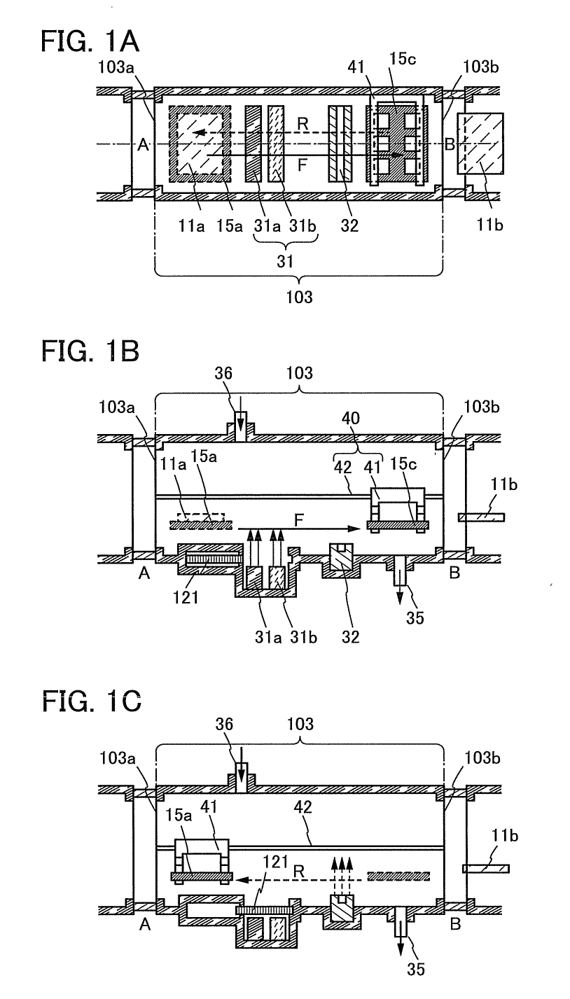

In this embodiment, a structure of a film formation apparatus of one embodiment of the present invention will be described with reference to FIGS. 1A to 1C. FIG. 1A is a top view of a structure of a film formation chamber 103 of the film formation apparatus of one embodiment of the present invention. FIGS. 1B and 1C are side views of the structure of the film formation chamber 103, which each include a cross section taken along line A-B in FIG. 1A.

The film formation apparatus exemplified in this embodiment includes the film formation chamber 103 that includes a film formation start position 103a, a film formation end position 103b, an evaporation source 31, a first sluice valve 121, and a plasma source 32. Moreover, the film formation apparatus includes a shadow mask transfer mechanism 40 which transfers a shadow mask between the film formation start position 103a and the film formation end position 103b.

The shadow mask transfer mechanism 40 is provided to perform a first transfer operation (indicated by a solid line arrow F in FIG. 1B from left to right) and a second transfer operation (indicated by a dashed line arrow R in FIG. 1C from right to left). In the first transfer operation, a shadow mask 15a before film formation whose one surface side faces an object to be film-formed before film formation (e.g., a substrate 11a) is transferred from the film formation start position 103a to the film formation end position 103b in the film formation chamber 103. In the second transfer operation, a shadow mask 15c after film formation is transferred from the film formation end position 103b to the film formation start position 103a.

The evaporation source 31 is provided so as to eject a film formation material to the substrate 11a before film formation from the other surface side of the shadow mask 15a before film formation during the first transfer operation.

The plasma source 32 is provided so as to remove a film formation material attached to the shadow mask 15c after film formation by irradiating the other surface side of the shadow mask 15c with plasma during the second transfer operation.

While plasma irradiation is performed by the plasma source 32, the first sluice valve 121 is provided so as to part the evaporation source 31 from the plasma source 32.

Here, a mode in which a film is formed on the substrate 11a with the film formation material ejected by the evaporation source 31 while the substrate 11a and the shadow mask 15a are transferred in a state of being overlapped with each other by the shadow mask transfer mechanism 40 is referred to as a first mode.

A mode in which plasma irradiation is performed by the plasma source 32 while the evaporation source 31 is parted from the plasma source 32 by the first sluice valve 121 and the shadow mask 15c is transferred in a state of being held by the shadow mask transfer mechanism 40 is referred to as a second mode.

Note that in the film formation apparatus exemplified in this embodiment, the operations of the shadow mask transfer mechanism 40 and the first sluice valve 121 can be controlled using, for example, a controller such as a sequencer.

Note that for convenience of explanation, a shadow mask before film formation is illustrated as the shadow mask 15a, and a shadow mask after film formation is illustrated as the shadow mask 15c. A shadow mask from which an attached film formation material is removed and which is reprocessed can be suitably used; therefore, such a shadow mask is illustrated as the shadow mask 15a before film formation. The first transfer operation is indicated by the solid line arrow F, and the second transfer operation is indicated by the dashed line arrow R.

Further, as an example of an object to be film-formed, the substrate 11a is illustrated as a substrate before film formation, and a substrate 11b is illustrated as a substrate after film formation.

The evaporation source 31 exemplified in this embodiment includes a first evaporation source 31a and a second evaporation source 31b. A co-evaporated layer can be formed by using different materials ejected by the first evaporation source 31a and the second evaporation source 31b.

The film formation chamber 103 includes an exhaust mechanism 35 and a gas introduction mechanism 36.

The shadow mask transfer mechanism 40 includes a track 42 provided on a side wall of the film formation chamber 103 and a carrier 41. The carrier 41 supports a shadow mask and a substrate, and the track 42 includes a driving mechanism that moves the carrier 41 along the track 42.

The film formation chamber 103 of the film formation apparatus exemplified in this embodiment includes the above-described components. Note that a unit for supplying the substrate 11a before film formation to the film formation chamber 103 can be provided on the film formation start position 103a side of the film formation chamber 103, and a unit for receiving the substrate 11b after film formation from the film formation chamber 103 can be provided on the film formation end position 103b side of the film formation chamber 103.

In the film formation apparatus exemplified in this embodiment, during the second transfer operation in which the shadow mask 15c after film formation is transferred from the film formation end position 103b to the film formation start position 103a, the evaporation source 31 is parted from the plasma source 32 by the first sluice valve 121 and the shadow mask 15c after film formation is irradiated with plasma by the plasma source 32, whereby the film formation material attached to the shadow mask 15c is removed. Accordingly, the film formation material attached to the shadow mask 15c after film formation can be removed without contaminating the film formation material in the evaporation source 31. Consequently, a film formation apparatus that can remove a film formation material attached to a shadow mask after film formation can be provided. Moreover, with the use of the film formation apparatus, it is possible to prevent entry of an impurity into the evaporation source 31 and reduce the frequency of occurrence of defects in a film to be formed, which is caused by the film formation material attached to the shadow mask after film formation.

The following describes individual components included in the film formation apparatus of one embodiment of the present invention.

### <Exhaust Mechanism and Gas Introduction Mechanism>

The film formation apparatus exemplified in this embodiment includes the exhaust mechanism 35 that controls the pressure inside the film formation chamber 103 and the gas introduction mechanism 36 that adjusts the atmosphere inside the film formation chamber 103.

As the exhaust mechanism 35, for example, a turbo pump, a cryopump, or the like can be used. In order to adjust the pressure of the film formation chamber 103, an automatic pressure controller can be used.

As the gas introduction mechanism 36, a mass flow meter or the like can be used. Note that the gas introduced into the film formation chamber 103 is preferred to have high purity, and, particularly, the content of an impurity which is contained unintentionally is preferably less than or equal to 1 ppm.

### <Film Formation Start Position and Film Formation End Position>

The film formation chamber 103 is provided with the film formation start position 103a and the film formation end position 103b. In this specification, a film formation start position is a position at which a substrate or a shadow mask before film formation is carried from another treatment chamber and is at least adjacent to a carrying-in port of a substrate in the film formation chamber. A film formation end position is a position from which a substrate or a shadow mask after film formation is carried out and is at least adjacent to a carrying-out port of the substrate in the film formation chamber.

The film formation start position 103a of the film formation apparatus exemplified in this embodiment is a carrying-in port for carrying in the substrate 11a before film formation to the film formation chamber 103, and the film formation end position 103b is a carrying-out port for receiving the substrate 11b after film formation from the film formation chamber 103 and carrying in the substrate to another treatment chamber.

### <First Transfer Operation and Second Transfer Operation>

In the first transfer operation (indicated by the solid line arrow F) exemplified in this embodiment, the shadow mask 15a before film formation whose one surface side faces the substrate 11a before film formation is transferred from the film formation start position 103a to the film formation end position 103b in the film formation chamber 103.

Note that the substrate 11a before film formation faces the one surface side of the shadow mask 15a while the shadow mask 15a is transferred from the film formation start position 103a to the film formation end position 103b.

In the second transfer operation (indicated by the dashed line arrow R) exemplified in this embodiment, the shadow mask 15c after film formation is transferred from the film formation end position 103b to the film formation start position 103a.

### <Shadow Mask Transfer Mechanism>

For the shadow mask transfer mechanism, various methods can be employed as long as the above first transfer operation and second transfer operation are performed.

In the first transfer operation, the shadow mask transfer mechanism transfers a shadow mask with a height with respect to an evaporation source kept constant while the other surface side of the shadow mask is exposed to the evaporation source.

In the second transfer operation, the shadow mask transfer mechanism transfers the shadow mask with a height with respect to a plasma source kept constant while the other surface side of the shadow mask is exposed to the plasma source.

The shadow mask transfer mechanism 40 exemplified in this embodiment includes the track 42 provided on a side wall of the film formation chamber 103 and the carrier 41. The carrier 41 can support a shadow mask and a substrate, and the track 42 includes a driving mechanism that moves the carrier 41 along the track 42. The distance between the shadow mask and the evaporation source 31 can be kept constant by keeping constant the distance between the evaporation source 31 and the track 42. Similarly, the distance between the shadow mask and the plasma source 32 can be kept constant by keeping constant the distance between the plasma source 32 and the track 42.

Note that the first transfer operation and the second transfer operation do not necessarily trace the same track; for example, the distance between the track of the first transfer operation and the evaporation source 31 may be longer or shorter than the distance between the track of the second transfer operation and the evaporation source 31.

Further, the speeds of the first transfer operation and the second transfer operation are not necessarily the same; for example, the speed of the first transfer operation may be lower than the speed of the second transfer operation.

### <Sluice Valve>

Any sluice valve can be used as the first sluice valve 121 as long as the evaporation source 31 can be parted from the plasma source 32 while plasma irradiation is performed by the plasma source 32, and as long as a phenomenon in which a substance that is generated from the film formation material attached to the shadow mask 15c, which is vaporized by exposure to plasma, is attached to the film formation material in the evaporation source 31 can be prevented.

As the first sluice valve 121, for example, a valve or the like that directly shuts off an ejection port of the evaporation source 31 can be used in addition to a door valve, a gate valve, or the like. Note that when the first sluice valve 121 with high airtightness is used, the pressure in the environment where the evaporation source 31 is parted can be kept constant in spite of the pressure in the environment where plasma irradiation is performed by the plasma source 32. Consequently, the variation in ejection speed of the evaporation source 31, which might be changed while plasma irradiation is performed by the plasma source 32, can be suppressed.

Moreover, between a nozzle and an accumulation portion of a film formation material in the evaporation source 31, an air chamber through which the vaporized film formation material passes from the accumulation portion is provided, and an inert gas or the like may be introduced into the air chamber so that the pressure inside the air chamber can be adjusted. Note that here, the inert gas refers to a gas that does not promote decomposition or reaction of a film formation material. For example, a rare gas or the like can be given as an example thereof.

By increasing the pressure inside the air chamber during the second transfer operation, the sluice valve having such a structure can prevent a phenomenon in which the substance which is vaporized by exposure to plasma enters from the nozzle to the accumulation portion and contaminates the film formation material in the evaporation source.

### <Evaporation Source>

Any evaporation source can be used as the evaporation source 31 as long as a film formation material can be ejected, and an evaporation source having directivity in a direction in which a film formation material is ejected is preferred because the material can be utilized efficiently.

As the evaporation source 31, an evaporation source from which a vaporized film formation material is ejected from slit-like spaces, as well as a point-source type evaporation source and an evaporation source in which point sources are arranged linearly or in matrix, can be given as an example.

Moreover, the evaporation source 31 is made to be able to move and may be combined with a method for forming a film while scanning the substrate with the evaporation source.

### <Plasma Source>

The plasma source 32 is not particularly limited as long as plasma that can remove the film formation material attached to the shadow mask 15c is generated without damage on the shadow mask 15c.

For example, the plasma source 32 may have either a structure in which plasma is generated in a discharge region in its vicinity (specifically, one electrode of a pair of parallel-plate electrodes) or a structure in which plasma is generated in a discharge region far from the plasma source 32 (also referred to as a remote plasma source).

In the case where one electrode of the pair of parallel-plate electrodes serves as the plasma source 32, the other electrode may serve as the shadow mask 15c. Alternatively, the shadow mask 15c during the second transfer operation may be provided between one electrode of the pair of parallel-plate electrodes, which serves as the plasma source 32, and the other electrode thereof.

In the case where a remote plasma source is used as the plasma source 32, for example, a hollow cathode type can be employed.

Moreover, plasma may be generated by either inductively coupled plasma method or an electron cyclotron resonance plasma method.

The gas used for plasma can be selected depending on a film formation material and a material of a shadow mask; for example, a rare gas (e.g., argon, xenon, or helium), a reducing gas (e.g., hydrogen), an oxidizing gas (e.g., oxygen), a halide gas (e.g., carbon tetrafluoride), or a gas in which any of these gases are mixed as appropriate can be used.

Alternatively, with the use of a linear laser as an auxiliary besides the plasma, an organic substance attached to the shadow mask 15c may be baked and separated from the shadow mask 15c to be removed by plasma.

Next, a method for forming a film and a method for cleaning a shadow mask, using the above film formation apparatus, will be exemplified.

### <Method for Forming Film and Method for Cleaning Shadow Mask, Using Film Formation Apparatus>

The method for forming a film and the method for cleaning a shadow mask which will be exemplified in this embodiment include four steps.

In a first step, during the first transfer operation (indicated by the arrow F in FIG. 1B), a film formation material is ejected by the evaporation source 31 from the other surface side of the shadow mask 15a to form a film on the substrate 11a (see FIG. 1B). Note that the substrate 11b on which the film is formed with the film formation material in the first step is carried out from the film formation chamber 103 with a unit for receiving the substrate 11b after film formation, which is not illustrated (e.g., a transfer robot).

In a second step, the evaporation source 31 is parted from the plasma source 32 with the first sluice valve 121.

In a third step, the other surface side of the shadow mask 15c is irradiated with plasma by the plasma source 32 to remove the film formation material attached to the shadow mask 15c while the second transfer operation (indicated by the arrow R in FIG. 1C) is performed after the pressure of the film formation chamber 103 is adjusted (see FIG. 1C).

In a fourth step, the first sluice valve 121 is opened to make the evaporation source 31 capable of forming a film after the pressure of the film formation chamber 103 is set equal to the pressure in the first step.

The method for forming a film and the method for cleaning a shadow mask which are exemplified in this embodiment include the following step: during the second transfer operation in which the shadow mask 15c is transferred from the film formation end position 103b to the film formation start position 103a of the film formation chamber 103, the shadow mask 15c is irradiated with plasma by the plasma source 32 with the evaporation source 31 parted from the plasma source 32 to remove the film formation material attached to the shadow mask 15c. Accordingly, the film formation material attached to the shadow mask 15c can be removed. Further, it is possible to suppress occurrence of a phenomenon in which a vaporized substance of the film formation material attached to the shadow mask 15c is attached to the film formation material. Consequently, a method for forming a film and a method for cleaning a shadow mask can be provided. Moreover, with the use of the method for forming a film and the method for cleaning a shadow mask, it is possible to prevent entry of an impurity into the evaporation source 31 and reduce the frequency of occurrence of defects in a film to be formed, which is caused by the film formation material attached to the shadow mask.

This embodiment can be combined as appropriate with any of the other embodiments described in this specification.

### Embodiment 2

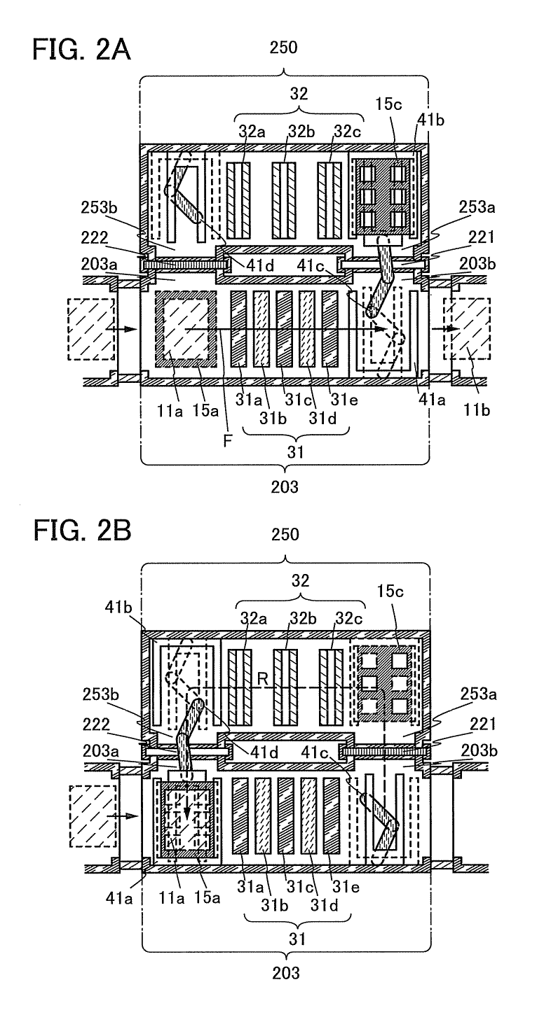

In this embodiment, another structure of a film formation apparatus of one embodiment of the present invention will be described with reference to FIGS. 2A and 2B. FIGS. 2A and 2B are top views of structures of a film formation chamber 203 and a removal chamber 250 of the film formation apparatus of one embodiment of the present invention.

The film formation apparatus exemplified in this embodiment includes the film formation chamber 203 that includes a film formation start position 203a, a film formation end position 203b, and an evaporation source 31; and a removal chamber 250 that includes a removal start position 253a, a removal end position 253b, and a plasma source 32. The film formation apparatus further includes a first sluice valve 221 between the film formation end position 203b and the removal start position 253a, a second sluice valve 222 between the removal end position 253b and the film formation start position 203a, and a shadow mask transfer mechanism which transfers a shadow mask between the film formation start position 203a and the film formation end position 203b.

The shadow mask transfer mechanism is provided to perform a first transfer operation (indicated by a solid line arrow F in FIG. 2A from the left to the right) and a second transfer operation (indicated by a dashed line arrow R in FIG. 2B from the lower right to upper right, upper left, and lower left in order). In the first transfer operation, the shadow mask 15a before film formation whose one surface side faces the substrate 11a before film formation is transferred from the film formation start position 203a to the film formation end position 203b in the film formation chamber 203. In the second transfer operation, the shadow mask 15c after film formation is transferred from the film formation end position 203b to the film formation start position 203a via the removal start position 253a, and the removal end position 253b in order.

The evaporation source 31 is provided so as to eject a film formation material to the substrate 11a before film formation from the other surface side of the shadow mask 15a before film formation during the first transfer operation.

The plasma source 32 is provided so as to remove a film formation material attached to the shadow mask 15c after film formation by irradiating the other surface side of the shadow mask 15c with plasma during the second transfer operation.

While plasma irradiation is performed by the plasma source 32, the evaporation source 31 is parted from the plasma source 32 with the first sluice valve 221 and the second sluice valve 222.

Here, a mode in which a film is formed on the substrate 11a with a film formation material ejected by the evaporation source 31 while the substrate 11a and the shadow mask 15a are transferred in a state of being overlapped with each other by the shadow mask transfer mechanism is referred to as a first mode.

A mode in which plasma irradiation is performed by the plasma source 32 while the evaporation source 31 is parted from the plasma source 32 by the first sluice valve 221 and the second sluice valve 222 and the shadow mask 15c is transferred in a state where the shadow mask 15c is held by the shadow mask transfer mechanism is referred to as a second mode.

Note that for convenience of explanation, a shadow mask before film formation is illustrated as the shadow mask 15a, and a shadow mask after film formation is illustrated as the shadow mask 15c. Note that a shadow mask from which an attached film formation material is removed and which is reprocessed can be suitably used; therefore, such a shadow mask is illustrated as the shadow mask 15a before film formation. The first transfer operation is indicated by the solid line arrow F, and the second transfer operation is indicated by the dashed line arrow R.

Further, the substrate 11a is illustrated as a substrate before film formation, and the substrate 11b is illustrated as a substrate after film formation.

The evaporation source 31 exemplified in this embodiment includes the first evaporation source 31a, the second evaporation source 31b, a third evaporation source 31c, a fourth evaporation source 31d, and a fifth evaporation source 31e.

Although not illustrated in FIGS. 2A and 2B, the film formation chamber 203 and the removal chamber 250 each include an exhaust mechanism and a gas introduction mechanism.

The shadow mask transfer mechanism exemplified in this embodiment includes the following two parts: one part where a shadow mask is transferred using a carrier moving along a track, and the other part where the shadow mask is transferred using a robot.

The part where the carrier moving along the track is used further includes the following two parts: one part where a first carrier 41a moves along a track (not illustrated) provided on a side wall of the film formation chamber 203, and the other part where a second carrier 41b moves along a track (not illustrated) provided on a side wall of the removal chamber 250. The carrier 41a supports a shadow mask and a substrate, and the carrier 41b supports the shadow mask. Note that each track includes a driving mechanism that moves the carrier along the track.

The part where the robot is used further includes the following two parts: one part where the shadow mask 15c after film formation is delivered from the first carrier 41a to the second carrier 41b with a first transfer robot 41c provided in the film formation chamber 203, and the other part where the shadow mask 15a from which the attached film formation material is removed is delivered from the second carrier 41b to the first carrier 41a with a second transfer robot 41d provided in the removal chamber 250.

The film formation chamber 203 or the removal chamber 250 of the film formation apparatus exemplified in this embodiment includes the above-described components. Note that a unit for supplying the substrate 11a before film formation to the film formation chamber 203 can be provided on the film formation start position 203a side of the film formation chamber 203, and a unit for receiving the substrate 11b after film formation from the film formation chamber 203 can be provided on the film formation end position 203b side of the film formation chamber 203.

In the film formation apparatus exemplified in this embodiment, during the second transfer operation in which the shadow mask is transferred from the film formation end position 203b to the film formation start position 203a, the evaporation source 31 is parted from the plasma source 32 by the first sluice valve 221 and the second sluice valve 222 and the shadow mask is irradiated with plasma by the plasma source 32, whereby the film formation material attached to the shadow mask is removed. Accordingly, the film formation material attached to the shadow mask can be removed without contaminating the film formation material in the evaporation source 31. Consequently, a film formation apparatus that can remove a film formation material attached to a shadow mask can be provided. Moreover, with the use of the film formation apparatus, the film formation material attached to the shadow mask can be removed in the removal chamber 250 which is different from the film formation chamber 203; therefore, it is possible to prevent entry of an impurity into the evaporation source 31 and reduce the frequency of occurrence of defects in a film to be formed, which is caused by the film formation material attached to the shadow mask.

The following describes individual components included in the film formation apparatus of one embodiment of the present invention.

### <Exhaust Mechanism and Gas Introduction Mechanism>

In the film formation apparatus exemplified in this embodiment, although not illustrated in FIGS. 2A and 2B, the following are included: an exhaust mechanism that can independently control the pressure inside the film formation chamber 203 and the removal chamber 250, and a gas introduction mechanism that can independently adjust the atmosphere inside the film formation chamber 203 and the removal chamber 250.

As the exhaust mechanism, for example, a turbo pump, a cryopump, or the like can be used. In order to adjust the pressure of the film formation chamber 203, an automatic pressure controller can be used.

As the gas introduction mechanism, a mass flow meter or the like can be used. Note that the gas introduced into the film formation chamber 203 is preferred to have high purity, and, particularly, the content of an impurity which is contained unintentionally is preferably less than or equal to 1 ppm.

### <Film Formation Start Position, Film Formation End Position, Removal Start Position, and Removal End Position>

The film formation chamber 203 is provided with the film formation start position 203a and the film formation end position 203b, and the removal chamber 250 is provided with the removal start position 253a and the removal end position 253b. In this specification, a removal start position is a position at which a shadow mask after film formation is carried from a film formation chamber and is at least adjacent to a carrying-in port of a shadow mask in the removal chamber. A removal end position is a position at which a shadow mask from which a film formation material is removed is carried out and is at least adjacent to a carrying-out port of the shadow mask in the removal chamber.

The film formation end position 203b of the film formation chamber 203 is adjacent to the removal start position 253a of the removal chamber 253 with the first sluice valve 221 provided therebetween, and the removal end position 253b of the removal chamber 250 is adjacent to the film formation start position 203a of the film formation chamber 203 with the second sluice valve 222 provided therebetween.

### <First Transfer Operation and Second Transfer Operation>

In the first transfer operation (indicated by the solid line arrow F in FIG. 2A) exemplified in this embodiment, the shadow mask 15a before film formation whose one surface side faces the substrate 11a before film formation is transferred from the film formation start position 203a to the film formation end position 203b in the film formation chamber 203.

In the second transfer operation (indicated by the dashed line arrow R in FIG. 2B), the shadow mask 15c after film formation is transferred to the film formation start position 203a of the film formation chamber 203 via the film formation end position 203b, the first sluice valve 221, the removal start position 253a, the removal end position 253b, the second sluice valve 222, and the film formation start position 203a in order.

### <Shadow Mask Transfer Mechanism>

For the shadow mask transfer mechanism, various methods can be employed as long as the above first transfer operation and second transfer operation are performed.

The shadow mask transfer mechanism exemplified in this embodiment includes a mechanism that moves the first carrier 41a which supports the shadow mask from the film formation start position 203a to the film formation end position 203b along the track (not illustrated) provided on a side wall of the film formation chamber 203. Note that after the first transfer operation, the transfer mechanism transfers the first carrier 41a which is empty from the film formation end position 203b to the film formation start position 203a.

The shadow mask transfer mechanism further includes the following: the first transfer robot 41c that remounts the shadow mask 15c after film formation from the first carrier 41a onto the second carrier 41b; a mechanism that moves the second carrier 41b which supports the shadow mask 15c from the removal start position 253a to the removal end position 253b along the track (not illustrated) provided on a side wall of the removal chamber 250; and the second transfer robot 41d that remounts the shadow mask 15a from which the attached film formation material is removed from the second carrier 41b onto the first carrier 41a.

Note that after the second transfer operation, the second carrier 41b which is empty is transferred from the removal end position 253b to the removal start position 253a.

### <First Sluice Valve>

Any sluice valve can be used as the first sluice valve 221 and the second sluice valve 222 as long as the evaporation source 31 can be parted from the plasma source 32 while plasma irradiation is performed by the plasma source 32, and a method similar to that in Embodiment 1 can be employed.

### <Evaporation Source>

Any evaporation source can be used as the evaporation source 31 as long as a film foiniation material can be ejected, and a method similar to that in Embodiment 1 can be employed.

### <Plasma Source>

The plasma source 32 may include one plasma source or a plurality of plasma sources. The plasma source 32 exemplified in this embodiment includes a first plasma source 32a, a second plasma source 32b, and a third plasma source 32c. With the use of two or more plasma sources using different gases, it is possible to remove a film formation material which is difficult to be removed by one plasma source. For example, when a plasma source using a halide gas is used together with a plasma source using only an oxidizing gas or a reducing gas, a film formation material containing an organic metal complex, which is attached to the shadow mask 15c, can be efficiently removed in some cases. Note that the plasma source 32 is not particularly limited as long as plasma that can remove the film formation material attached to the shadow mask 15c is generated without damage on the shadow mask 15c. For example, a plasma source similar to that in Embodiment 1 can be employed.

Next, a method for forming a film and a method for cleaning a shadow mask, using the above film formation apparatus, will be exemplified.

### <Method for Forming Film and Method for Cleaning Shadow Mask, Using Film Formation Apparatus>

The method for forming a film and the method for cleaning a shadow mask which will be exemplified in this embodiment include four steps.

In a first step, during the first transfer operation, a film formation material is ejected by the evaporation source 31 from the other surface side of the shadow mask 15a to form a film on the substrate 11a.

In a second step, the first sluice valve 221 is opened to carry in the shadow mask 15c from the film formation end position 203b of the film formation chamber 203 to the removal start position 253a of the removal chamber 250, and the first sluice valve 221 and the second sluice valve 222 are closed to part the evaporation source 31 from the plasma source 32.

In a third step, the other surface side of the shadow mask 15c is irradiated with plasma by the plasma source 32 to remove the film formation material attached to the shadow mask 15c after the pressure of the removal chamber 250 is adjusted.

In a fourth step, the second sluice valve 222 is opened to carry in the shadow mask 15a from the removal end position 253b of the removal chamber 250 to the film formation start position 203a of the film formation chamber 203 after the pressure of the removal chamber 250 is set equal to the pressure of the film formation chamber 203.

The method for forming a film and the method for cleaning a shadow mask which are exemplified in this embodiment include the following step: during the second transfer operation in which the shadow mask 15c is transferred from the film formation end position 203b to the film formation start position 203a of the film formation chamber 203, the shadow mask 15c is irradiated with plasma by the plasma source 32 in the removal chamber 250 whose pressure is different from that of the film formation chamber 203 with the plasma source 32 parted from the evaporation source 31 to remove the film formation material attached to the shadow mask 15c. Accordingly, the film formation material attached to the shadow mask 15c can be removed. Further, it is possible to suppress occurrence of a phenomenon in which a vaporized substance of the film formation material attached to the shadow mask 15c is attached to the film formation material in the evaporation source 31. Furthermore, the pressure of the film formation chamber 203 can be kept at a pressure appropriate for film formation. Consequently, a method for forming a film and a method for cleaning a shadow mask can be provided. Moreover, with the use of the method for forming a film and the method for cleaning a shadow mask, it is possible to prevent entry of an impurity into the evaporation source 31 and reduce the frequency of occurrence of defects in a film to be formed, which is caused by the film formation material attached to the shadow mask. Further, the film formation material in the evaporation source 31 is unlikely to be contaminated with the vaporized substance. Furthermore, while the film formation material attached to the shadow mask used for film formation on one substrate is removed in the removal chamber 250 through the third step, a film can also be formed on another substrate using another shadow mask in the film formation chamber 203 through the first step; therefore, the efficiency of the film formation and cleaning can be improved.

This embodiment can be combined as appropriate with any of the other embodiments described in this specification.

### Embodiment 3

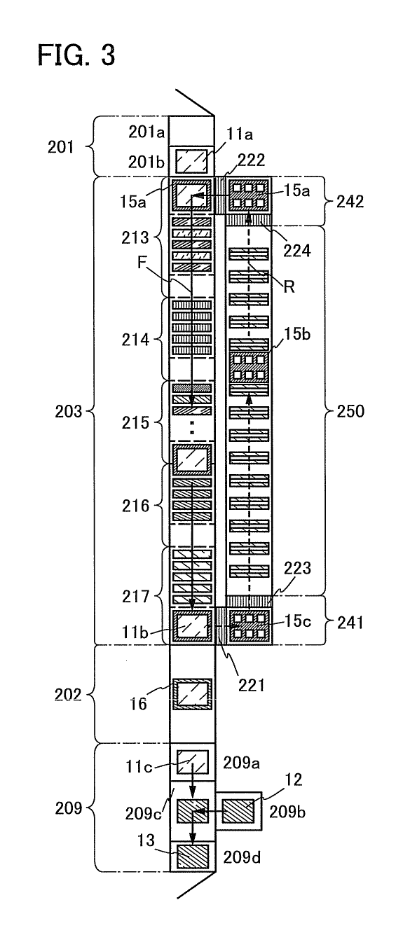

In this embodiment, another structure of a film formation apparatus of one embodiment of the present invention will be described with reference to FIG. 3. FIG. 3 is a top view of a structure of the film formation apparatus of one embodiment of the present invention. Note that a film formation apparatus exemplified in this embodiment is a modification example of the film formation apparatus described in Embodiment 2.

The film formation apparatus exemplified in this embodiment includes the following in addition to the components of the fihn formation apparatus described in Embodiment 2: a first pressure adjustment chamber 241 between the first sluice valve 221 and the removal chamber 250, which is partitioned from the removal chamber 250 with a third sluice valve 223; and a second pressure adjustment chamber 242 between the second sluice valve 222 and the removal chamber 250, which is partitioned from the removal chamber 250 with a fourth sluice valve 224.

Instead of the second transfer operation described in Embodiment 2, a shadow mask transfer mechanism is provided to perform a second transfer operation in which a shadow mask is transferred from the film formation end position to the film formation start position via the first pressure adjustment chamber 241, the removal start position, the removal end position, and the second pressure adjustment chamber 242 in order.

In the film formation apparatus exemplified in this embodiment, although not illustrated in FIG. 3, an exhaust mechanism is at least included in the film formation chamber 203, and an exhaust mechanism and a gas introduction mechanism are at least included in the removal chamber 250.

The shadow mask transfer mechanism can include the following two parts by modifying as appropriate the shadow mask transfer mechanism exemplified in this Embodiment 2: one part where a shadow mask is transferred using a carrier moving along a track, and the other part where the shadow mask is transferred using a robot. Therefore, the description of Embodiment 2 is referred to, and a detailed drawing and description of the structure of this embodiment is omitted.

The film formation apparatus exemplified in this embodiment includes a substrate carrying-in portion 201, a second film formation chamber 202, and a sealing portion 209 in addition to the film formation chamber 203 and the removal chamber 250. Note that the substrate carrying-in portion 201 includes a pressure adjustment chamber 201a and a substrate storage chamber 201b. The sealing portion 209 includes a pressure adjustment chamber 209a, a sealing substrate storage chamber 209b, a sealing chamber 209c, and an extraction chamber 209d.

Note that for convenience of explanation, a shadow mask before film formation is illustrated as the shadow mask 15a, a shadow mask after film formation is illustrated as the shadow mask 15c, and a shadow mask while a film formation material is removed is illustrated as a shadow mask 15b. Note that a shadow mask from which an attached film formation material is removed and which is reprocessed can be suitably used; therefore, such a shadow mask is illustrated as the shadow mask 15a before film formation. A first transfer operation is indicated by a solid line arrow F, and the second transfer operation is indicated by a dashed line arrow R.

A shadow mask used in the second film formation chamber 202 is illustrated as a shadow mask 16. Note that a removal chamber that removes a film formation material attached to the shadow mask 16 is not illustrated in FIG. 3 but may be additionally provided.

Further, the substrate 11a is illustrated as a substrate before film formation, the substrate 11b is illustrated as a substrate after film formation in the film formation chamber 203, and a substrate 11c is illustrated as a substrate after film formation in the second film formation chamber 202.

A sealing substrate 12 is used to seal a formed film between the substrate 11c and the sealing substrate 12.

A panel 13 is obtained by attaching the substrate 11c and the sealing substrate 12 to each other.

In the film formation apparatus exemplified in this embodiment, during the second transfer operation in which the shadow mask 15c is transferred from the film formation end position to the film formation start position, the evaporation source is parted from the plasma source by the first pressure adjustment chamber 241 and the second pressure adjustment chamber 242 and the shadow mask 15c is irradiated with plasma by the plasma source, whereby the film formation material attached to the shadow mask 15c is removed. Accordingly, the pressure of the removal chamber 250 can be kept at a pressure appropriate for the removal and the pressure of the film formation chamber 203 can be kept at a pressure appropriate for film formation, and further the film formation material attached to the shadow mask 15c can be removed without contaminating the film formation material in the evaporation source. Consequently, a method for forming a film and a film formation apparatus that can remove a film formation material attached to a shadow mask can be provided. Moreover, with the use of the film formation apparatus, it is possible to prevent entry of an impurity into the evaporation source and reduce the frequency of occurrence of defects in a film to be formed, which is caused by the film formation material attached to the shadow mask. Further, the film formation material in the evaporation source is unlikely to be contaminated with the vaporized substance. Furthermore, the time needed to remove the film formation material attached to the shadow mask can be reduced.

The following describes individual components included in the film formation apparatus of one embodiment of the present invention.

### <Exhaust Mechanism and Gas Introduction Mechanism>

In the film formation apparatus exemplified in this embodiment, although not illustrated in FIG. 3, the following are included: an exhaust mechanism that can independently control the pressure inside the film formation chamber 203, the removal chamber 250, the first pressure adjustment chamber 241, and the second pressure adjustment chamber 242; and a gas introduction mechanism that can independently adjust the atmosphere inside the film formation chamber 203, the removal chamber 250, the first pressure adjustment chamber 241, and the second pressure adjustment chamber 242.

As the exhaust mechanism, for example, a turbo pump, a cryopump, or the like can be used. In order to adjust the pressure of the film formation chamber 203, an automatic pressure controller can be used.

As the gas introduction mechanism, a mass flow meter or the like can be used. Note that the gas introduced into the film formation chamber 203 is preferred to have high purity, and, particularly, the content of an impurity which is contained unintentionally is preferably less than or equal to 1 ppm.

### <Pressure Adjustment Chamber>

The film formation apparatus exemplified in this embodiment includes the first pressure adjustment chamber 241 and the second pressure adjustment chamber 242.

The first pressure adjustment chamber 241 is connected to the film formation chamber 203 through the first sluice valve 221 and to the removal chamber 250 through the third sluice valve 223.

The second pressure adjustment chamber 242 is connected to the film formation chamber 203 through the second sluice valve 222 and to the removal chamber 250 through the fourth sluice valve 224.

With such a structure, the shadow mask can be transferred from the film formation chamber 203 to the removal chamber 250 or vice versa while the film formation chamber 203 and the removal chamber 250 are kept at different pressures.

### <First Transfer Operation and Second Transfer Operation>

In the first transfer operation (indicated by the solid line arrow F in FIG. 3) exemplified in this embodiment, the shadow mask 15a before film formation whose one surface side faces the substrate 11a before film formation is transferred to the film formation end position in the film formation chamber 203.

In the second transfer operation (indicated by the dashed line arrow R in FIG. 3), the shadow mask 15c after film formation is transferred to the film formation start position of the film formation chamber 203 via the first sluice valve 221, the first adjustment chamber 241, the third sluice valve 223, the removal chamber 250, the fourth sluice valve 224, the second adjustment chamber 242, the second sluice valve 222, and the film formation start position in order.

### <Shadow Mask Transfer Mechanism>

The shadow mask transfer mechanism may be any as long as the above first transfer operation and second transfer operation are performed and can be combined as appropriate with, for example, the mechanism exemplified in Embodiment 2.

### <Structure of Film Formation Chamber>

The film formation apparatus exemplified in this embodiment includes the film formation chamber 203 that can form a film while a plurality of films are stacked. Thus, a plurality of films are stacked also on the shadow mask 15a before film formation.

Specifically, the film follnation chamber 203 is divided into a plurality of region so that a plurality of films can be stacked. A film in contact with the substrate 11a is formed in a first region 213, a film in contact with the film formed in the first region 213 is formed in a second region 214, a film in contact with the film formed in the second region 214 is formed in a third region 215, a film in contact with the film formed in the third region 215 is formed in a fourth region 216, and a film in contact with the film formed in the fourth region 216 is formed in a fifth region 217.

Note that in order to remove the plurality of films attached to the shadow mask 15c after film formation, a plurality of plasma sources may be provided in the removal chamber 250 so that plasma irradiation is performed using different gases. For example, in the case where a film which is easily removed with reducing gas plasma is stacked over a film which is easily removed with oxidizing gas plasma, a plasma source which performs irradiation with reducing gas plasma and a plasma source which performs irradiation with oxidizing gas plasma are provided in order in the direction of the second transfer operation. Accordingly, films having different properties can be removed easily.

This embodiment can be combined as appropriate with any of the other embodiments described in this specification.

### Embodiment 4

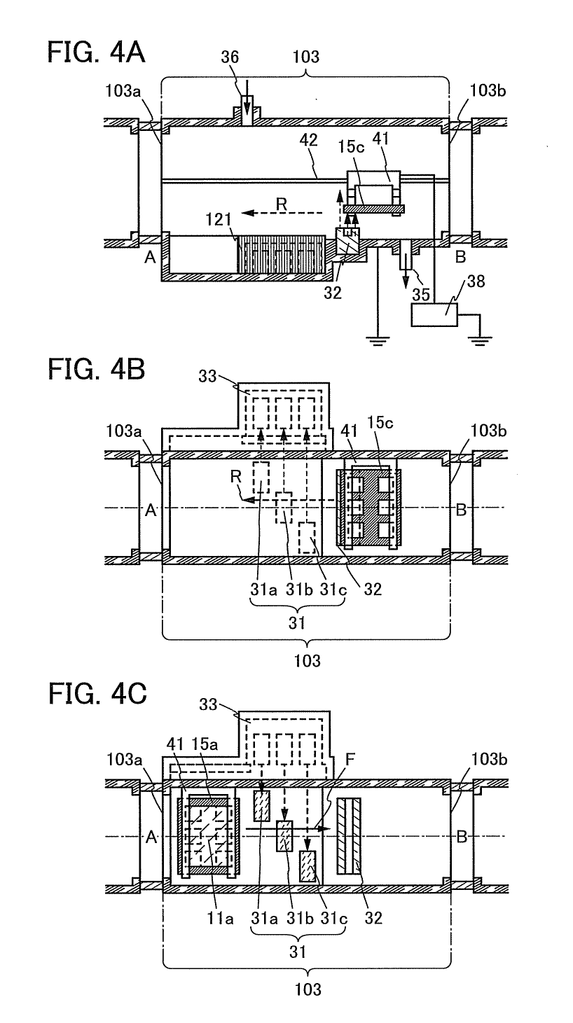

In this embodiment, another structure of a film formation apparatus of one embodiment of the present invention will be described with reference to FIGS. 4A to 4C. FIGS. 4B and 4C are top views of a structure of the film formation chamber 103 of the film formation apparatus of one embodiment of the present invention, and FIG. 4A is a side view of the structure of the film formation chamber 103, which includes a cross section taken along line A-B in FIG. 4B.

Note that a film formation apparatus exemplified in this embodiment is a modification example of the film formation apparatus described in Embodiment 1.

The film formation apparatus exemplified in this embodiment includes a power source 38 electrically connected to the shadow mask 15c and a storage chamber 33 in addition to the components of the film formation apparatus described in Embodiment 1. During the second transfer operation, the power source 38 controls a potential of the shadow mask 15c so that part of plasma generated by the plasma source 32 is drawn to the shadow mask 15c, and the storage chamber 33 stores an evaporation source group 31.

Note that for convenience of explanation, a shadow mask before film formation is illustrated as the shadow mask 15a, and a shadow mask after film formation is illustrated as the shadow mask 15c. A first transfer operation is indicated by a solid line arrow F, and a second transfer operation is indicated by a dashed line arrow R.

The film formation chamber 103 includes the exhaust mechanism 35 and the gas introduction mechanism 36.

The shadow mask transfer mechanism 40 includes the track 42 provided on the side wall of the film formation chamber 103 and the carrier 41. The carrier 41 supports a shadow mask and a substrate and moves along the track 42.

The film formation chamber 103 of the film formation apparatus exemplified in this embodiment includes the above-described components. Note that a unit for supplying a substrate before film formation to the film formation chamber 103 can be provided on the film formation start position 103a side of the film formation chamber 103, and a unit for receiving a substrate after film formation from the film formation chamber 103 can be provided on the film formation end position 103b side of the film formation chamber 103.

The above film formation apparatus of the one embodiment of the present invention can selectively clean the shadow mask 15c by drawing plasma to the shadow mask 15c. Accordingly, the film formation material attached to a complicated portion of the shadow mask 15c can be removed. Further, the shadow mask can be selectively irradiated with plasma having high capability of removing the film formation material attached to the shadow mask 15c. Consequently, a method for forming a film and a film formation apparatus that can remove a film formation material attached to a shadow mask can be provided. Moreover, with the use of the film formation apparatus, it is possible to reduce the frequency of occurrence of defects in a film to be formed, which is caused by the film formation material attached to the shadow mask 15c. Further, the film formation material attached to the shadow mask 15c can be removed efficiently.

The film formation apparatus exemplified in this embodiment further includes the evaporation source group 31 (specifically, the first evaporation source 31a, the second evaporation source 31b, and the third evaporation source 31c) and the storage chamber 33 connected to the film formation chamber 103 through the first sluice valve 121. The evaporation sources of the evaporation source group 31 are provided so as to be able to move between the film formation chamber 103 and the storage chamber 33 and to move parallel to one another in a direction intersecting with the direction of the first transfer operation.

During the first transfer operation, the evaporation sources of the evaporation source group 31 are arranged in the film formation chamber 103 so as not to be aligned with one another (see FIG. 4C). The evaporation source group 31 is stored in the storage chamber 33 during the second transfer operation (see FIG. 4B).

In the film formation apparatus exemplified in this embodiment, the evaporation source group 31 is provided so as to be able to move in a direction intersecting with the direction of the first transfer operation, and the evaporation sources of the evaporation source group 31 during the first transfer operation are arranged in the film formation chamber 103 so as not to be aligned with one another. Accordingly, a film with a large width can be formed in a direction in which the evaporation source group 31 intersects with the direction of the first transfer operation without using a large-sized evaporation source. Note that a large-sized evaporation source is difficult to move; thus, film formation can be achieved by using a plurality of small-sized evaporation sources which can be moved easily.

During the second transfer operation, the evaporation source group 31 is stored in the storage chamber 33 to be parted from the plasma source 32, and the shadow mask 15c is irradiated with plasma by the plasma source 32, whereby the film formation material attached to the shadow mask 15c is removed.

Accordingly, the film formation material attached to the shadow mask 15c can be removed. Consequently, a method for foaming a film and a film formation apparatus that can remove a film formation material attached to a shadow mask can be provided. Moreover, with the use of the film formation apparatus, it is possible to prevent entry of an impurity into the film formation material in the evaporation source group 31 and reduce the frequency of occurrence of defects in a film to be formed, which is caused by the film formation material attached to the shadow mask.

The evaporation source group 31 is provided so as to be able to move between the film formation chamber 103 and the storage chamber 33 and to move parallel to one another in a direction intersecting with the direction of the first transfer operation.

Accordingly, the evaporation source group 31 that can form a film with a large width in a direction intersecting with the direction of the first transfer operation can be stored in the storage chamber 33. By particularly using an evaporation source group 31 including small evaporation sources, the length of the storage chamber 33 which is projected from the side surface of the film formation chamber 103 can be made short, and an occupation area or a footprint of the film formation apparatus can be made small. Further, by using the first sluice valve, the evaporation source group 31 can be parted from the plasma source 32.

The following describes individual components included in the film formation apparatus of one embodiment of the present invention.

### <Power Source>

The film formation apparatus exemplified in this embodiment includes the power source 38 electrically connected to the shadow mask 15c. With the power source 38, the potential of the shadow mask 15c can be adjusted.

For example, the potential of the shadow mask 15c can be made different from that of the plasma source 32, or a high-frequency voltage can be applied to the shadow mask 15c. Accordingly, active species included in plasma (e.g., a radical) can be attracted to the shadow mask 15c; thus, the attached film formation material can be removed efficiently.

Further, ion-assisted etching can be performed by providing an ion gun together with the plasma source 32 to simultaneously irradiate the shadow mask with plasma and an ion, and electron-assisted etching can be performed by providing an electron gun together with the plasma source 32 to simultaneously irradiate the shadow mask with plasma and an electron.

### <Storage Chamber>

The film formation apparatus exemplified in this embodiment further includes the storage chamber 33 connected to the film formation chamber 103 through the first sluice valve 121. The storage chamber 33 stores the evaporation source group 31 (specifically, the first evaporation source 31a, the second evaporation source 31b, and the third evaporation source 31c), and can be parted from the plasma source 32 by the first sluice valve 121.

### <Evaporation Source Group>

The evaporation sources of the evaporation source group 31 of the film formation apparatus exemplified in this embodiment are provided so as to be able to move between the film formation chamber 103 and the storage chamber 33 and to move parallel to one another in a direction intersecting with the direction of the first transfer operation. The evaporation sources of the evaporation source group 31 can be moved by, for example, a method using a robot or a method in which a track parallel to each evaporation source is provided to move the evaporation sources.

During the first transfer operation, the evaporation sources of the evaporation source group 31 are arranged in the film formation chamber 103 so as not to be aligned with one another. When the evaporation sources of the evaporation source group 31 are arranged in a direction intersecting with the direction of the first transfer operation, a film with a large width can be formed.

During the second transfer operation, the evaporation sources of the evaporation source group 31 are arranged and stored in the storage chamber 33.

Next, a method for forming a film and a method for cleaning a shadow mask, using the above film formation apparatus, will be exemplified.

### <Method for Forming Film and Method for Cleaning Shadow Mask, Using Film Formation Apparatus>

The method for forming a film and the method for cleaning a shadow mask which will be exemplified in this embodiment include four steps.

In a first step, during the first transfer operation (indicated by the arrow F in FIG. 4C), a film formation material is ejected by the evaporation source group 31 from the other surface side of the shadow mask 15a to form a film on the substrate 11a.

In a second step, the evaporation source group 31 is moved to the storage chamber 33 and is parted from the plasma source 32 with the first sluice valve 121 (see FIG. 4B).

In a third step, the other surface side of the shadow mask 15c is irradiated with plasma by the plasma source 32 during the second transfer operation (indicated by the arrow R in FIG. 4A) to remove the film formation material attached to the shadow mask 15c after the pressure of the film formation chamber 103 is adjusted.

Note that in the third step, a potential of the shadow mask 15c is controlled with the power source 38 so that part of plasma generated by the plasma source 32 is drawn to the shadow mask 15c.

In a fourth step, the first sluice valve 121 is opened to make the evaporation source group 31 capable of forming a film after the pressure of the film formation chamber 103 is set equal to the pressure in the first step.

Note that the third step of the method for forming a film and the method for cleaning a shadow mask which are exemplified in this embodiment is modified as appropriate, so that such a step can be applied to the third step of the method for forming a film and the method for cleaning a shadow mask described in Embodiments 1 to 2, which include four steps. Consequently, a function and an effect similar to those in this embodiment can be obtained.

The above method for forming a film and method for cleaning a shadow mask of one embodiment of the present invention include the following step: during the second transfer operation in which the shadow mask 15c is transferred from the film formation end position 103b to the film formation start position 103a of the film formation chamber 103, the shadow mask 15c is irradiated with plasma by the plasma source 32 with the evaporation source group 31 parted from the plasma source 32 to remove the film formation material attached to the shadow mask 15c. Accordingly, the film formation material attached to the shadow mask can be removed. Further, it is possible to suppress occurrence of a phenomenon in which a vaporized substance of the film formation material attached to the shadow mask is attached to the film formation material. Furthermore, in order to suppress the variation in ejection speed of the evaporation source group 31, the pressure of the storage chamber 33 can be kept constant with the use of the first sluice valve. Therefore, the pressure of the film formation chamber can be kept at a pressure appropriate for film formation in a film formation process, and the pressure of the film formation chamber can be kept at a pressure appropriate for the removal of the film formation material attached to the shadow mask in a cleaning process. Further, part of plasma can be drawn to the shadow mask. Consequently, a method for forming a film and a method for cleaning a shadow mask can be provided. Further, with the method for forming a film and the method for cleaning a shadow mask, the film formation material in the evaporation source is unlikely to be contaminated with the vaporized substance. Furthermore, since part of plasma is drawn to the shadow mask, the time needed to remove the film formation material attached to the shadow mask can be reduced.

This embodiment can be combined as appropriate with any of the other embodiments described in this specification.

### Embodiment 5

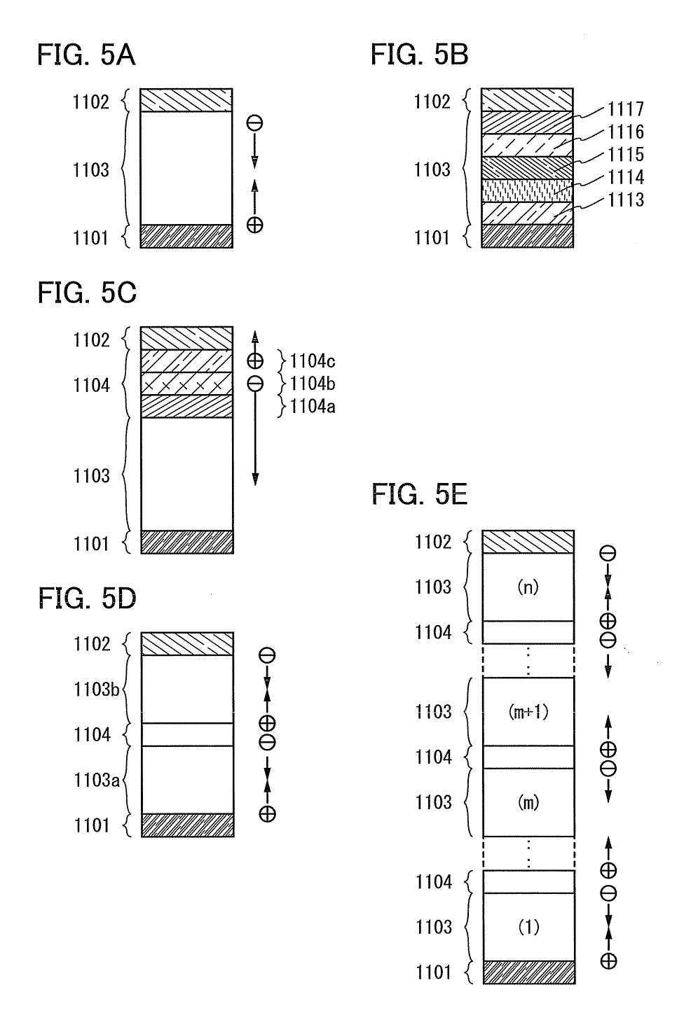

In this embodiment, examples of a structure of a light-emitting element which can be formed using a film formation apparatus and a film formation method of one embodiment of the present invention will be described with reference to FIGS. 5A to 5E.

For example, with the film formation apparatus described in Embodiment 3, a light-emitting element having a structure similar to that of Structure Example 1 of a light-emitting element, which will be exemplified below, can be formed.

Specifically, with a substrate over which a plurality of anodes 1101 are formed in matrix, in the film formation chamber 203, a hole-injection layer 1113 is formed in the first region 213, a hole-transport layer 1114 is formed in the second region 214, a light-emitting layer 1115 is formed in the third region 215, an electron-transport layer 1116 is formed in the fourth region 216, an electron-injection layer 1117 is formed in the fifth region 217, and a cathode 1102 is formed in the second film formation chamber 202, whereby a light-emitting panel can be obtained. Since particularly the film formation apparatus of one embodiment of the present invention can remove a film formation material attached to a shadow mask without contaminating the film formation material in the evaporation source, a film having a high quality can be formed and a light-emitting panel having high reliability can be obtained.

The light-emitting element exemplified in this embodiment includes a first electrode, a second electrode, and a layer including a light-emitting organic compound (hereinafter referred to as an EL layer) between the first and second electrodes. One of the first and second electrodes serves as an anode, and the other serves as a cathode. The EL layer is provided between the first and second electrodes, and a structure of the EL layer may be selected as appropriate in accordance with materials of the first and second electrodes. Examples of the structure of the light-emitting element are described below; it is needless to say that the structure of the light-emitting element is not limited to this examples.

### <Structure Example 1 of Light-Emitting Element>

An example of the structure of the light-emitting element is illustrated in FIG. 5A. In the light-emitting element illustrated in FIG. 5A, the EL layer is provided between the anode 1101 and the cathode 1102.

Upon application of a voltage higher than the threshold voltage of the light-emitting element between the anode 1101 and the cathode 1102, holes are injected to the EL layer from the anode 1101 side and electrons are injected to the EL layer from the cathode 1102 side. The injected electrons and holes recombine in the EL layer, so that a light-emitting substance contained in the EL layer emits light.

In this specification, a layer or a stack which includes one region where electrons and holes injected from both ends recombine is referred to as a light-emitting unit. Therefore, Structure Example 1 of the light-emitting element includes one light-emitting unit.

A light-emitting unit 1103 may include at least one light-emitting layer including a light-emitting substance, and may have a structure in which the light-emitting layer and a layer other than the light-emitting layer are stacked. Examples of the layer other than the light-emitting layer include layers containing a substance having a high hole-injection property, a substance having a high hole-transport property, a substance having a poor hole-transport property (a substance which blocks holes), a substance having a high electron-transport property, a substance having a high electron-injection property, and a substance having a bipolar property (a substance having high electron-and hole-transport properties).

An example of a specific structure of the light-emitting unit 1103 is illustrated in FIG. 5B. In the light-emitting unit 1103 illustrated in FIG. 5B, the hole-injection layer 1113, the hole-transport layer 1114, the light-emitting layer 1115, the electron-transport layer 1116, and the electron-injection layer 1117 are stacked in this order from the anode 1101 side.

### <Structure Example 2 of Light-Emitting Element>

Another example of the structure of the light-emitting element is illustrated in FIG. 5C. In the light-emitting element illustrated in FIG. 5C, an EL layer including the light-emitting unit 1103 is provided between the anode 1101 and the cathode 1102. Further, an intermediate layer 1104 is provided between the cathode 1102 and the light-emitting unit 1103. Note that a structure similar to that of the light-emitting unit included in Structure Example 1 of the light-emitting element, which is described above, can be applied to the light-emitting unit 1103 in Structure Example 2 of the light-emitting element and that the description of Structure Example 1 of the light-emitting element can be referred to for the details.

The intermediate layer 1104 includes at least a charge generation region, and may have a structure in which the charge generation region and a layer other than the charge generation region are stacked. For example, a structure can be employed in which a first charge generation region 1104c, an electron-relay layer 1104b, and an electron-injection buffer 1104a are stacked in this order from the cathode 1102 side.

The behavior of electrons and holes in the intermediate layer 1104 is described. When a voltage higher than the threshold voltage of the light-emitting element is applied between the anode 1101 and the cathode 1102, holes and electrons are generated in the first charge generation region 1104c, and the holes are transferred to the cathode 1102 and the electrons are transferred to the electron-relay layer 1104b. The electron-relay layer 1104b has a high electron-transport property and immediately transfers the electrons generated in the first charge generation region 1104c to the electron-injection buffer 1104a. The electron-injection buffer 1104a can reduce a barrier against electron injection into the light-emitting unit 1103, so that the efficiency of the electron injection into the light-emitting unit 1103 can be improved. Thus, the electrons generated in the first charge generation region 1104c are injected into the LUMO level of the light-emitting unit 1103 through the electron-relay layer 1104b and the electron-injection buffer 1104a.

In addition, the electron-relay layer 1104b can prevent interaction in which, for example, a substance included in the first charge generation region 1104c and a substance included in the electron-injection buffer 1104a react with each other at the interface thereof to impair the functions of the first charge generation region 1104c and the electron-injection buffer 1104a.

The range of choices of materials that can be used for the cathode in Structure Example 2 of the light-emitting element is wider than that of materials that can be used for the cathode in Structure Example 1. This is because a material having a relatively high work function can be used for the cathode in Structure Example 2 as long as the cathode can receive holes generated by the intermediate layer.

### <Structure Example 3 of Light-Emitting Element>

Another example of the structure of the light-emitting element is illustrated in FIG. 5D. In the light-emitting element illustrated in FIG. 5D, an EL layer including two light-emitting units is provided between the anode 1101 and the cathode 1102. Furthermore, the intermediate layer 1104 is provided between a first light-emitting unit 1103a and a second light-emitting unit 1103b.

Note that the number of the light-emitting units provided between the anode and the cathode is not limited to two. A light-emitting element illustrated in FIG. 5E has what is called a tandem structure, that is, a structure in which a plurality of light-emitting units 1103 are stacked. Note that in the case where n (n is a natural number greater than or equal to 2) light-emitting units 1103 are provided between the anode and the cathode, for example, the intermediate layer 1104 is provided between an mth (m is a natural number greater than or equal to 1 and less than or equal to n−1) light-emitting unit and an (m+1)th light-emitting unit.

Note that a structure similar to that in Structure Example 1 of the light-emitting element can be applied to the light-emitting unit 1103 in Structure Example 3 of the light-emitting element; a structure similar to that in Structure Example 2 of the light-emitting element can be applied to the intermediate layer 1104 in Structure Example 3 of the light-emitting element. Thus, for the details, the description of the Structure Example 1 of the light-emitting element or the Structure Example 2 of the light-emitting element can be referred to.

The behavior of electrons and holes in the intermediate layer 1104 provided between the light-emitting units is described. Upon application of a voltage higher than the threshold voltage of the light-emitting element between the anode 1101 and the cathode 1102, holes and electrons are generated in the intermediate layer 1104, and the holes are transferred to the light-emitting unit provided on the cathode 1102 side and the electrons are transferred to the light-emitting unit provided on the anode 1101 side. The holes injected into the light-emitting unit provided on the cathode side recombine with the electrons injected from the cathode side, so that a light-emitting substance contained in the light-emitting unit emits light. The electrons injected into the light-emitting unit provided on the anode side recombine with the holes injected from the anode side, so that a light-emitting substance contained in the light-emitting unit emits light. Thus, the holes and electrons generated in the intermediate layer 1104 cause light emission in the respective light-emitting units.

Note that in the case where a structure which is the same as the intermediate layer is formed between the light-emitting units by providing the light-emitting units in contact with each other, the light-emitting units can be formed to be in contact with each other. Specifically, when one surface of the light-emitting unit is provided with a charge generation region, the charge generation region functions as a first charge generation region of the intermediate layer; thus, the light-emitting units can be provided in contact with each other.

The Structure Examples 1 to 3 of the light-emitting element can be implemented in combination. For example, an intermediate layer can be provided between the cathode and the second light-emitting unit in Structure Example 3 of the light-emitting element.

Further, a plurality of light-emitting substances which emit light of different colors can be used, whereby, for example, white light emission can also be obtained by expanding the width of the emission spectrum. Note that in order to obtain white light emission, for example, a structure may be employed in which at least two layers containing light-emitting substances are provided so that light of complementary colors is emitted. Specific examples of complementary colors are “blue and yellow” and “blue-green and red”.

Further, in order to obtain white light emission with an excellent color rendering property, an emission spectrum is preferred to spread through the entire visible light region. For example, a light-emitting element may include layers emitting light of blue, green, and red.

This embodiment can be combined as appropriate with any of the other embodiments described in this specification.

### Embodiment 6

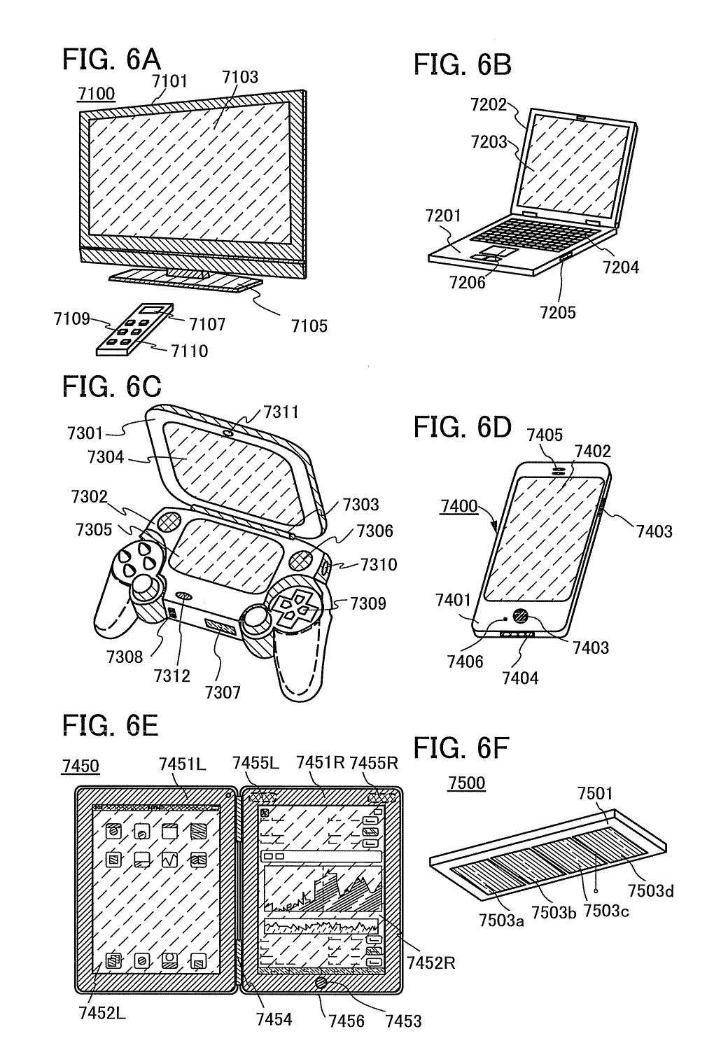

In this embodiment, electronic devices of one embodiment of the present invention will be described. Specifically, electronic devices each including a light-emitting panel manufactured using the film formation apparatus of any of the film formation apparatuses of one embodiment of the present invention will be described with reference to FIGS. 6A to 6F.

Examples of the electronic devices to which the light-emitting panel is applied include television devices (also referred to as televisions or television receivers), monitors of computers or the like, cameras such as digital cameras or digital video cameras, digital photo frames, cellular phones (also referred to as mobile phones or cellular phone sets), portable game consoles, portable information terminals, audio reproducing devices, large-sized game machines such as pachinko machines, and the like. Specific examples of these electronic devices are illustrated in FIGS. 6A to 6F.

FIG. 6A illustrates an example of a television device. In a television device 7100, a display portion 7103 is incorporated in a housing 7101. Images can be displayed by the display portion 7103, and the light-emitting panel can be used for the display portion 7103. In addition, here, the housing 7101 is supported by a stand 7105.

The television device 7100 can be operated by an operation switch of the housing 7101 or a separate remote controller 7110. With operation keys 7109 of the remote controller 7110, channels and volume can be controlled and images displayed on the display portion 7103 can be controlled. Furthermore, the remote controller 7110 may be provided with a display portion 7107 for displaying data output from the remote controller 7110.

Note that the television device 7100 is provided with a receiver, a modem, and the like. With the receiver, general television broadcasting can be received. Furthermore, when the television device 7100 is connected to a communication network by wired or wireless connection via the modem, one-way (from a transmitter to a receiver) or two-way (between a transmitter and a receiver, between receivers, or the like) data communication can be performed.

FIG. 6B illustrates a computer, which includes a main body 7201, a housing 7202, a display portion 7203, a keyboard 7204, an external connecting port 7205, a pointing device 7206, and the like. This computer is manufactured by using the light-emitting panel for the display portion 7203.

FIG. 6C illustrates a portable game machine, which includes two housings, a housing 7301 and a housing 7302, which are connected with a joint portion 7303 so that the portable game machine can be opened or folded. A display portion 7304 is incorporated in the housing 7301 and a display portion 7305 is incorporated in the housing 7302. In addition, the portable game machine illustrated in FIG. 6C includes a speaker portion 7306, a recording medium insertion portion 7307, an LED lamp 7308, an input means (an operation key 7309, a connection terminal 7310, a sensor 7311 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, tilt angle, vibration, smell, or infrared rays), or a microphone 7312), and the like. It is needless to say that the structure of the portable game machine is not limited to the above as long as the light-emitting panel is used for at least either the display portion 7304 or the display portion 7305, or both, and another accessory can be provided as appropriate. The portable game machine illustrated in FIG. 6C has a function of reading out a program or data stored in a storage medium to display it on the display portion, and a function of sharing information with another portable game machine by wireless communication. Note that functions of the portable game machine illustrated in FIG. 6C are not limited to them, and the portable game machine can have various functions.

FIG. 6D illustrates an example of a cellular phone. A cellular phone 7400 is provided with a display portion 7402 incorporated in a housing 7401, operation buttons 7403, an external connection port 7404, a speaker 7405, a microphone 7406, and the like. Note that the cellular phone 7400 is manufactured using the light-emitting panel for the display portion 7402.

When the display portion 7402 of the cellular phone 7400 illustrated in FIG. 6D is touched with a finger or the like, data can be input into the cellular phone 7400. Further, operations such as making calls and composing e-mails can be performed by touching the display portion 7402 with a finger or the like.

There are mainly three screen modes of the display portion 7402. The first mode is a display mode mainly for displaying an image. The second mode is an input mode mainly for inputting information such as characters. The third mode is a display-and-input mode in which two modes of the display mode and the input mode are mixed.

For example, in the case of making a call or composing an e-mail, a text input mode mainly for inputting text is selected for the display portion 7402 so that text displayed on a screen can be inputted. In that case, it is preferred that a keyboard or number buttons are displayed on almost all the area of the screen of the display portion 7402.

When a detection device including a sensor for detecting inclination, such as a gyroscope or an acceleration sensor, is provided inside the cellular phone 7400, display on the screen of the display portion 7402 can be automatically changed by determining the orientation of the cellular phone 7400 (whether the cellular phone 7400 is placed horizontally or vertically for a landscape mode or a portrait mode).

The screen modes are switched by touching the display portion 7402 or operating the operation buttons 7403 of the housing 7401. Alternatively, the screen modes can be switched depending on kinds of images displayed on the display portion 7402. For example, when a signal for an image displayed in the display portion is data of moving images, the screen mode is switched to the display mode. When the signal is text data, the screen mode is switched to the input mode.

Moreover, in the input mode, when input by touching the display portion 7402 is not performed within a specified period while a signal detected by an optical sensor in the display portion 7402 is detected, the screen mode may be controlled so as to be switched from the input mode to the display mode.

The display portion 7402 can function as an image sensor. For example, an image of a palm print, a fingerprint, or the like is taken by touching the display portion 7402 with the palm or the finger, whereby personal authentication can be performed. Furthermore, by provision of a backlight or a sensing light source emitting a near-infrared light for the display portion, an image of a finger vein, a palm vein, or the like can also be taken.

FIG. 6E illustrates an example of a folding computer. A folding computer 7450 includes a housing 7451L and a housing 7451R connected by hinges 7454. The computer 7450 further includes an operation button 7453, a left speaker 7455L, and a right speaker 7455R. In addition, a side surface of the computer 7450 is provided with an external connection port 7456, which is not illustrated. Note that when the computer 7450 is folded on the hinges 7454 so that a display portion 7452L provided in the housing 7451L and a display portion 7452R provided in the housing 7451R can face each other, the display portions can be protected by the housings.

Each of the display portions 7452L and 7452R is a component which can display images and to which data can be input by touch with a finger or the like. For example, the icon for the installed program is selected by touch with a finger, so that the program can be started. Further, changing the distance between fingers touching two positions of the displayed image enables zooming in or out on the image. Drag of a finger touching one position of the displayed image enables drag and drop of the image. Selection of the displayed character or symbol on the displayed image of a keyboard by touch with a finger enables information input.

Further, the computer 7450 can also include a gyroscope, an acceleration sensor, a global positioning system (GPS) receiver, fingerprint sensor, or a video camera. For example, when a detection device including a sensor for detecting inclination, such as a gyroscope or an acceleration sensor, is provided, the orientation of the display screen can be automatically changed by determining the orientation of the computer 7450 (whether the computer 7450 is placed horizontally or vertically).

Furthermore, the computer 7450 can be connected to a network. The computer 7450 not only can display data on the Internet but also can be used as a terminal which controls another electronic device connected to the network from a distant place.

FIG. 6F illustrates an example of a lighting device. In a lighting device 7500, light-emitting devices 7503a, 7503b, 7503c, and 7503d of one embodiment of the present invention are incorporated in a housing 7501 as light sources. The lighting device 7500 can be attached to a ceiling, a wall, or the like.

This embodiment can be combined as appropriate with any of the other embodiments described in this specification.

This application is based on Japanese Patent Application serial No. 2012-032933 filed with the Japan Patent Office on Feb. 17, 2012, the entire contents of which are hereby incorporated by reference.

What is claimed is:

1. A film formation apparatus comprising:
an evaporation source in a chamber;
a plasma source in the chamber;
a valve configured to part a first region including the evaporation source from a second region including the plasma source; and
a transfer mechanism in the chamber,
wherein the transfer mechanism is configured to move an object, on which an evaporation is performed by the evaporation source, and a mask over the evaporation source in a first mode, and move the mask over the plasma source in a second mode.

2. The film formation apparatus according to claim 1, wherein the valve is configured to open in the first mode and close in the second mode.

3. The film formation apparatus according to claim 1, wherein the evaporation source is configured to move between the first region and the second region.

4. The film formation apparatus according to claim 1, further comprising:
a power source electrically connected to the mask; and
a controller configured to control a potential of the mask so that plasma generated by the plasma source is drawn to the mask in the second mode.

5. The film formation apparatus according to claim 1, further comprising:
a pressure controller configured to control a pressure in the chamber before any of the first mode and the second mode.

6. The film formation apparatus according to claim 1, further comprising:
a second evaporation source in the chamber.

7. The film formation apparatus according to claim 1, further comprising:
a second plasma source in the chamber.

8. A film formation apparatus comprising:
an evaporation source in a first chamber;
a plasma source in a second chamber;
a first valve between the first chamber and the second chamber;
a second valve between the first chamber and the second chamber;
a first transfer mechanism in the first chamber; and
a second transfer mechanism in the second chamber,
wherein the first transfer mechanism is configured to move an object, on which an evaporation is performed by the evaporation source, and a mask over the evaporation source in a first mode, and the second transfer mechanism is configured to move the mask over the plasma source in a second mode.

9. The film formation apparatus according to claim 8, further comprising:
a first pressure adjustment chamber between the first valve and the second chamber, the first pressure adjustment chamber being partitioned from the second chamber with a third valve; and
a second pressure adjustment chamber between the second valve and the second chamber, the second pressure adjustment chamber being partitioned from the second chamber with a fourth valve.

10. The film formation apparatus according to claim 8, wherein the first valve is configured to open after the first mode, the second valve is configured to open after the second mode, and the first valve and the second valve are configured to close in the first mode and the second mode.

11. The film formation apparatus according to claim 8, further comprising:
a power source electrically connected to the mask; and
a controller configured to control a potential of the mask so that plasma generated by the plasma source is drawn to the mask in the second mode.

12. The film formation apparatus according to claim 8, further comprising:
a second evaporation source in the first chamber.

13. The film formation apparatus according to claim 8, further comprising:
a second plasma source in the second chamber.

14. The film formation apparatus according to claim 8, further comprising:
a first arm configured to move the mask from the first chamber to the second chamber; and
a second arm configured to move the mask from the second chamber to the first chamber.

15. A method for cleaning a mask comprising:
a first step of forming a film on an object with a material ejected from an evaporation source while moving the object and a mask in a chamber;
a second step of parting a first region including the evaporation source from a second region including a plasma source by a valve; and
a third step of performing plasma irradiation by the plasma source to remove the material attached to the mask in the first step while moving the mask in the chamber.

16. The method for cleaning a mask according to claim 15, further comprising: a step of moving the evaporation source from the first region to the second region before the first step.

17. The method for cleaning a mask according to claim 15, wherein a potential of the mask is controlled so that plasma generated by the plasma source is drawn to the mask in the third step.

18. The method for cleaning a mask according to claim 15, further comprising:
a step of controlling a pressure in the chamber before the first step; and
a step of controlling a pressure in the chamber before the third step.

19. The method for cleaning a mask according to claim 15, further comprising: a step of ejecting a second material from a second evaporation source during the first step.

20. The method for cleaning a mask, according to claim 15, further comprising: a step of performing plasma irradiation by a second plasma source during the third step.
